(19) United States
(12) Patent Application Publication
(10) Pub. No.: US 2026/0092673 A1
(43) Pub. Date: Apr. 2, 2026

(54) CURVED FRAME MODULE AND CURVED DISPLAY MODULE INCLUDING THE SAME

(71) Applicant: AUO Corporation, Hsinchu City (TW)

(72) Inventors: Li-Yuan LIAO, Hsinchu City (TW); Chien-Hsin LIN, Hsinchu City (TW)

(21) Appl. No.: 19/310,352

(22) Filed: Aug. 26, 2025

(30) Foreign Application Priority Data
Oct. 1, 2024 (TW) 113137633

(51) Int. Cl. F16M 11/42; G09F 9/302

(52) U.S. Cl. CPC F16M 11/42; G09F 9/3023

(57) ABSTRACT

The present disclosure provides a curved frame module and a curved display module including the same. Each module unit of the curved frame module includes: a base frame defining a virtual curved surface and having protruding ledges; a plurality of first brackets disposed on the ledges; a plurality of second brackets extending longitudinally and each having a rib; and a plurality of connecting components each having a first flange and a second flange respectively connected to the corresponding first bracket and the corresponding rib. The first brackets include a plurality of first positioning portions having positioning holes and guiding grooves. The ribs include a plurality of second positioning portions each having a guiding piece, an opening connected to the guiding piece, and a positioning bump extending into the opening. The guiding piece and the positioning bump are respectively inserted into the guiding groove and the positioning hole.

### CROSS REFERENCE TO RELATED APPLICATION

This application claims the priority benefit of Taiwan Patent Application No. 113137633, filed on Oct. 1, 2024. The entirety of the mentioned above patent application is hereby incorporated by reference herein and made a part of this specification.

### BACKGROUND OF THE DISCLOSURE

### 1. Field of the Disclosure

The present disclosure relates to a curved frame module and a curved display module including the same. Specifically, the present disclosure relates to a curved frame module having first brackets and second brackets cross-stacked to form a curved positioning surface and a curved display module including the same.

### 2. Description of the Prior Art

With the development and advancement of display technology, the applications and fields of display devices have gradually expanded. Among them, curved displays or spherical displays provide enhanced coverage and surround effects, thereby offering better visual performance and immersive experience. As a result, such curved or spherical displays have gradually emerged and demonstrate significant application potential. However, constructing a curved or spherical display and a corresponding supporting structure presents various challenges. These challenges are especially prominent in large-scale display applications where such displays are particularly popular, making the assembly and integration of curved or spherical displays even more difficult and complex.

For example, when relatively large components or modules are used to construct a curved or spherical display, their transportation and assembly become more difficult and hazardous. Conversely, when relatively small components or modules are used, the assembly process becomes more tedious and complicated. Such a tedious assembly process tends to accumulate assembly tolerances or misalignments, potentially causing assembly failure or producing a final product deviating from the intended design. As mentioned above, due to the inherently three-dimensional nature of curved and spherical surfaces, imprecise positioning during assembly can easily lead to distortion or twisting of the overall structure, causing deviation from the intended curvature or radius. Therefore, there is a need to develop curved or spherical displays that are easy to assemble and capable of being precisely positioned.

### SUMMARY OF THE DISCLOSURE

To overcome the aforementioned problems, a curved frame module is provided in an embodiment of the present invention. The curved frame module includes at least one module unit. Each module unit includes a base frame, a plurality of first brackets, a plurality of second brackets, and a plurality of connecting components. The base frame includes a first frame, a second frame, and a plurality of ledges respectively protruding from the first frame and the second frame. A virtual curved surface is defined to span between an edge of the first frame and a corresponding edge of the second frame. The first brackets are disposed on the ledges and laterally extending along the virtual curved surface, wherein each first bracket has a plurality of first positioning portions. Each first positioning portion comprises a positioning hole and a guiding groove spaced apart from each other, and the axial direction of the guiding groove passes through the positioning hole and the center of curvature of the virtual curved surface. The second brackets longitudinally extend along the virtual curved surface, wherein each second bracket at least has a rib. Each rib has a plurality of second positioning portions, and each second positioning portion has a guiding piece, an opening connected to the guiding piece, and a positioning bump extending into the opening. The guiding piece and the positioning bump are respectively inserted into the guiding groove and the positioning hole. Each connecting component has a first flange and a second flange respectively connected to the corresponding first bracket and the corresponding rib.

In another embodiment of the present invention, a curved display module is provided. The curved display module includes the aforementioned curved frame module, and at least one display panel. For each module unit in the curved frame module, the second brackets together form a curved positioning surface. Each display panel is disposed on the curved positioning surface and has a display surface facing away from the curved positioning surface.

According to the curved frame module and the curved display module disclosed in various embodiments of the present invention, the parts or components of the modular framework can be produced in a simplified segmented manner. The production of large parts or components using individual molds is not required, thereby facilitating the handling and assembly of the parts or components. Furthermore, various structures and designs for alignment are provided to improve convenience and positioning accuracy of the assembly process, thereby preventing assembly failures and errors in the three-dimensional framework with large number of parts or components.

### BRIEF DESCRIPTION OF THE DRAWINGS

FIG. 1 is a 3D schematic diagram of the curved frame module in an embodiment.

FIG. 2 is a two-part exploded view of a module unit in an embodiment.

FIG. 3 is a simplified top view of the base frame and one of the first brackets of the module unit in the embodiment shown in FIG. 2.

FIG. 4 is an enlarged view illustrating the connection of the first bracket and the ledge of the module unit in the embodiment shown in FIG. 2.

FIG. 5 is a 3D schematic diagram of the first brackets and the base frame of the module unit in the embodiment shown in FIG. 2.

FIG. 6 shows a 3D schematic diagram of the assembly of the first brackets and the second brackets and an enlarged view of a portion of the first bracket and a portion of the second bracket at a pre-assembly state in an embodiment.

FIG. 7 shows a simplified top view of a first bracket and an enlarged view of a portion of the first bracket and a second bracket at a pre-assembly state in the embodiment shown in FIG. 6.

FIG. 8 shows an overview and an enlarged view of the assembly of the first brackets, the second brackets, and the connecting components in an embodiment.

FIG. 9 is a side view of the first brackets and a second bracket in an embodiment.

FIG. 10 is a 3D schematic diagram of using the lateral inspection tool to inspect the positioning accuracy of the assembly of the first brackets and the second brackets in an embodiment.

FIG. 11 is a side cross-sectional view of a portion of the lateral inspection tool and a portion of the second bracket in the embodiment shown in FIG. 10.

FIG. 12 is a 3D schematic diagram of the back side of the curved frame module in an embodiment.

FIG. 13 is an enlarged view of the lateral connecting region between the module units in the curved frame module in the embodiment shown in FIG. 12.

FIG. 14 is a 3D schematic diagram of the curved frame module formed by longitudinally connection of module units in an embodiment.

FIG. 15 is a 3D schematic diagram of the back side of the curved frame module in the embodiment shown in FIG. 14.

FIG. 16 is an enlarged view of the longitudinal connecting region between the module units in the curved frame module in the embodiment shown in FIG. 14.

FIG. 17 is a 3D schematic diagram of the curved frame module formed by lateral connection of a plurality of module units in an embodiment.

FIG. 18 is a 3D schematic diagram of the curved frame module formed by both lateral and longitudinal connection of a plurality of module units in an embodiment.

### DETAILED DESCRIPTION OF THE DISCLOSURE

Various embodiments will be described below, and a person having ordinary skill in the art can easily understand the spirits and principles of the present disclosure referring to this specification accompanied by the drawings. However, although some particular embodiments will be specifically illustrated herein, these embodiments are only exemplary, and are not regarded as limiting or exhaustive in all respects. Therefore, for a person having ordinary skill in the art, various changes and modifications to the present disclosure should be obvious and can be easily achieved without departing from the spirits and principles of the present disclosure.

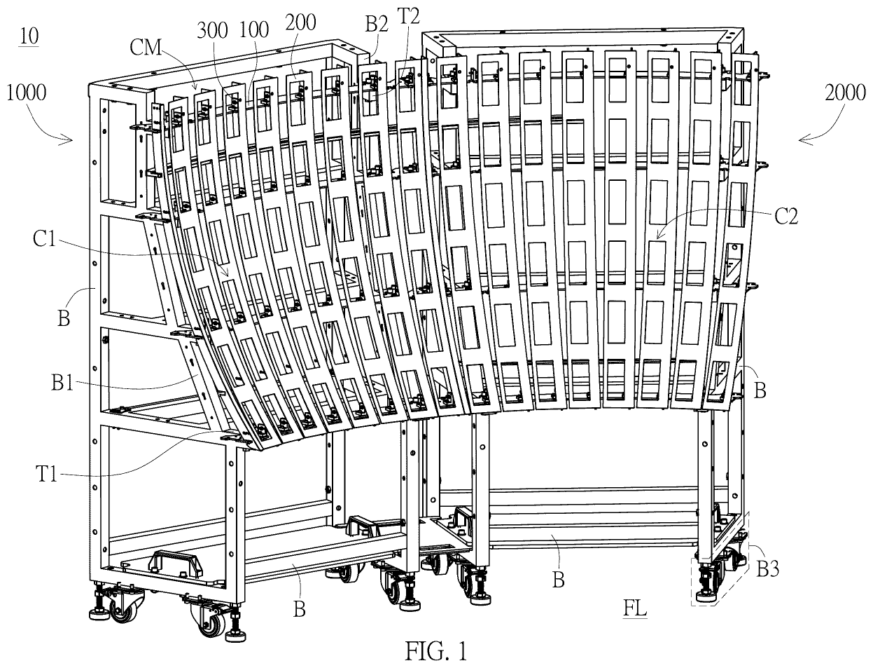

Referring to FIG. 1, a curved frame module 10 including at least one module unit is provided in an embodiment of the present disclosure. For example, the curved frame module 10 may include module units 1000 and 2000 with the same or similar configurations. The module units 1000 and 2000 may respectively form the curved positioning surface C1 and the curved positioning surface C2, which may be used to support a predetermined curved object. For example, the curved positioning surfaces C1 and C2 may be configured to hold at least one display panel to construct a curved display module. However, the above embodiment is merely exemplary. Based on other embodiments of the present disclosure, the curved frame module 10 can serve as a framework for constructing a curved positioning surface in various application fields as needed, and such possible variations are not described in detail herein.

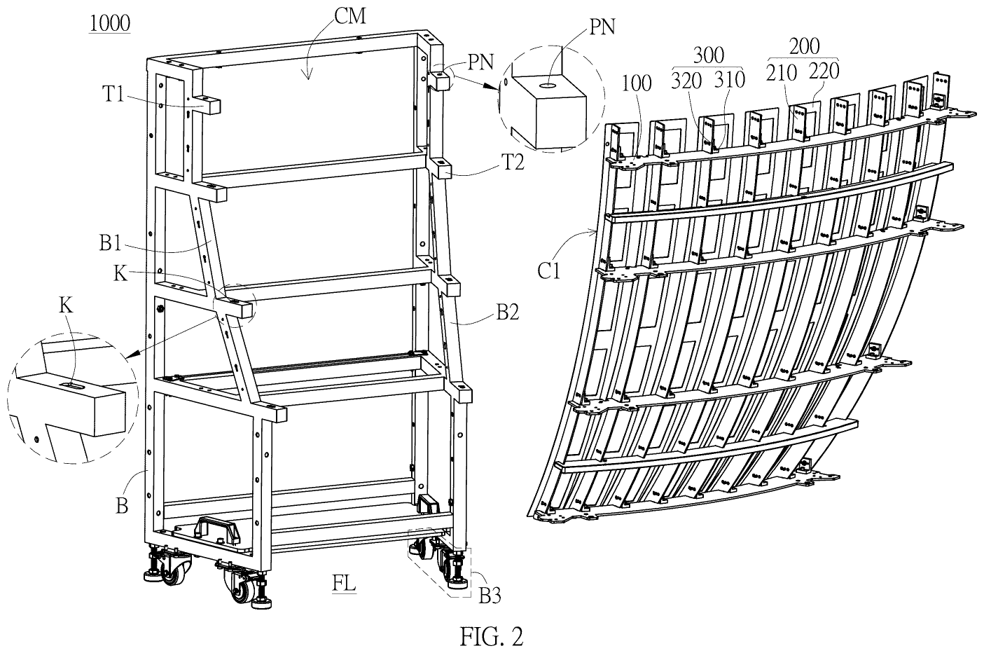

Hereinafter, referring to FIGS. 1 and 2, the module unit 1000 will be used as an example to specifically illustrate the detailed structure of the curved frame module 10.

In this embodiment, the module units 1000 may include a base frame B disposed on the reference surface FL (such as the ground), a plurality of first brackets 100 and a plurality of second brackets 200 stacked on the base frame B to form the curved positioning surface C1, and a plurality of connecting components 300 for connecting and securing the first brackets 100 and the second brackets 200.

Specifically, the base frame B may be constructed by connecting common structural members (such as tubular or solid bars) via welding, screw fastening, or other means. The base frame B may have at least one base support B3 configured to support the base frame B on a reference surface FL. Based on some embodiments, when multiple module units are assembled or the reference surface FL shows a height variation, the height of the one or more base supports B3 relative to the reference surface FL may be adjusted, allowing for height adjustment of the first brackets 100 and the second brackets 200 disposed on the base frame B.

The base frame B may include a first frame B1, a second frame B2, and a plurality of ledges T1 and T2 respectively protruding from the first frame B1 and the second frame B2. A virtual curved surface CM is defined to span from the first frame B1 to the second frame B2. Specifically, the first frame B1 and the second frame B2 may be integrally formed or assembled into substantially curved shapes. The first frame B1 and the second frame B2 may be disposed on opposite sides of the base frame B, thereby defining the boundary and curvature of the virtual curved surface CM. The first brackets 100 and the second brackets 200, which have curved shapes, may be arranged on the virtual curved surface CM in a stacked manner, thereby constructing a corresponding curved positioning surface C1. In details, each first bracket 100 may laterally extend along the virtual curved surface CM (for example, along a horizontal arc located on the virtual curved surface CM) and be positioned on a pair of the ledges T1 and T2. Each second brackets 200 may longitudinally extend along the virtual curved surface CM (for example, along a vertical arc located on the virtual curved surface CM) and be engaged with the first brackets 100. Therefore, the first brackets 100 may be supported by the ledges T1 and T2 and be limited to the designated height level (for example, relative to the gravity direction), and the second brackets 200 may be supported by the first brackets 100. Based on this configuration, the first brackets 100 may extend across multiple second brackets 200, and the second brackets 200 may also extend across multiple first brackets 100. That is, the first brackets 100 and the second brackets 200 may intersect to form a grid-like structure, as shown in the right of FIG. 2. Therefore, instead of using an integrated box-like structure, those separated components, including the first brackets 100 (as horizontal skeletons) and the second brackets 200 (as vertical skeletons) can be cross-arranged to form the predetermined, curved positioning surface C1.

In this disclosure, the terms “lateral” and “longitudinal” refer to directions defined relative to the module unit, rather than to absolute spatial directions. Accordingly, the meanings of these terms change consistently with the orientation of the module unit.

Specifically, each second bracket 200 may at least have a rib 210 engaging with the first brackets 100. In addition, to enhance the flatness and stability of the curved positioning surface C1, each second bracket 200 may further have a bracket plate 220 cross-connected to the rib 210 and positioned corresponding to the virtual curved surface CM. The bracket plates 220 of the second brackets 200 may together form the curved positioning surface C1 of the module unit 1000, allowing the predetermined object to be positioned evenly and firmly on the curved positioning surface C1. Moreover, portions of the second brackets 200 (such as a portion of each bracket plate 220) may be hollowed or perforated to reduce weight or facilitate wiring connection while maintaining structural stability and supporting performance.

As mentioned above, the first brackets 100 and the second brackets 200 may be connected and secured by the connecting components 300. In an embodiment, the connecting components 300 may be, for example, but not limited to, L-shaped connecting components. As shown in FIG. 2, the first brackets 100 and the ribs 210 of the second brackets 200 are cross-stacked, wherein each connecting components 300 may have a first flange 310 and a second flange 320 respectively connected to a corresponding first bracket 100 and a corresponding rib 210. Based on this configuration, the initially separated first brackets 100 and second brackets 200 can be connected and secured to form a supporting block of the curved positioning surface C1.

Hereinafter, the module unit 1000 will be used as an example to specifically illustrate the structures and designs for precise locating and assembly of the curved frame module 10.

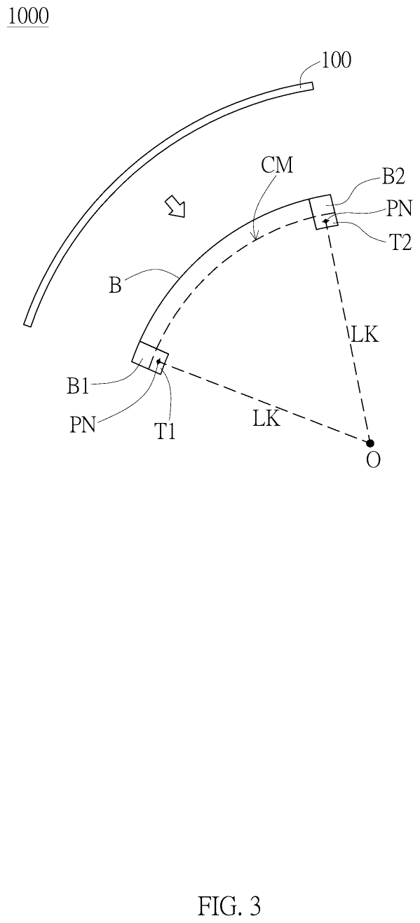

Referring to FIGS. 2 and 3, in this embodiment, both the ledges T1 and T2 may have reference holes PN to provide the initial alignment of the first brackets 100. The first brackets 100 may be respectively positioned on the corresponding pairs of the ledges T1 and T2 based on the reference holes PN before being firmly secured.

The relative location of the reference holes PN in the module units 1000 is shown in FIG. 3. In order to precisely position the first brackets 100 corresponding to the virtual curved surface CM, the reference holes PN is designed to be spaced apart from the center of curvature O of the virtual curved surface CM by a predetermined radial distance LK. Since the virtual curved surface CM has a curved shape, it can be challenging to visually align both ends of each first bracket 100 on the ledges T1 and T2, leading to unintended displacement or deviation of the first brackets 100 relative to the virtual curved surface CM. Therefore, by initially aligning both ends of each first bracket 100 to the reference holes PN, the distance between each end of the first bracket 100 to the center of curvature O of the virtual curved surface CM can be limited to a predetermined range, thereby preventing large displacement or deviation of the curved positioning surface C1 (supported by the first brackets 100 and the second bracket 200) relative to the virtual curved surface CM.

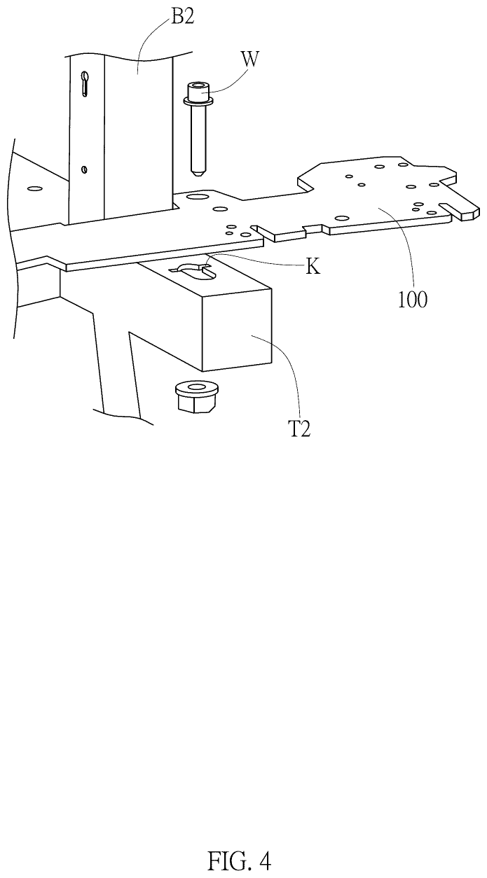

After initially aligning the first brackets 100 to the reference holes PN, various means can be further applied to position and secure the first brackets 100 on the ledges T1 and the ledges T2. For example, as illustrated by the ledge T2 shown in FIG. 4, the first bracket 100 may be fastened to the ledge T2 through a screw W. However, the above embodiment is merely exemplary. Based on other embodiments of the present disclosure, the first bracket 100 may be secured by other means such as welding, which is not limited to the illustration in this embodiment.

In addition, based on some embodiments of the present disclosure, the ledges T1 and T2 may respectively have alignment recesses K at the same horizontal level. For example, as shown in FIG. 4, the alignment recess K may be a linear mark, but not limited thereto. In addition, the alignment recess K may, for example, but not limited to, correspond to the edge of the first bracket 100 toward the first frame B1 or the second frame B2 for lateral alignment of the first bracket 100, facilitating the consistency in horizontal layout between the first brackets 100 which have different lengths and are supported by different pairs of ledges T1 and T2 at different height levels. However, the above embodiment is merely exemplary. Based on other embodiments of the present disclosure, the alignment recess K may instead correspond to the edge of the first bracket 100 away from the first frame B1 or the second frame B2; the alignment recess K may also correspond to another portion of the first bracket 100 for alignment. As described above, the shape and position of the alignment recess K, which are designed to enhance the consistency in horizontal layout between the first brackets 100, are not limited to the particular forms illustrated or described herein

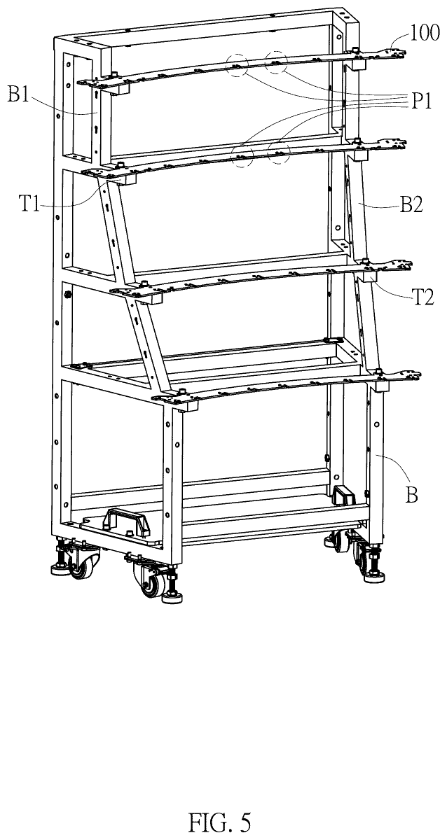

As mentioned above, referring to FIG. 5, the first brackets 100 may have different lengths and be positioned on different pairs of ledges T1 and T2 at different height levels, thereby being positioned on the base frame B. In addition, each first bracket 100 may have a plurality of the first positioning portions P1 arranged along the lateral extending direction. Each second brackets 200 may be positioned on the first brackets 100 in alignment with the corresponding first positioning portions P1. In detail, each second bracket 200 may be aligned and positioned on the first positioning portions P1 of different first brackets 100 corresponding to a vertical direction, and different second brackets 200 may correspond to different first positioning portions P1 on the same first bracket 100.

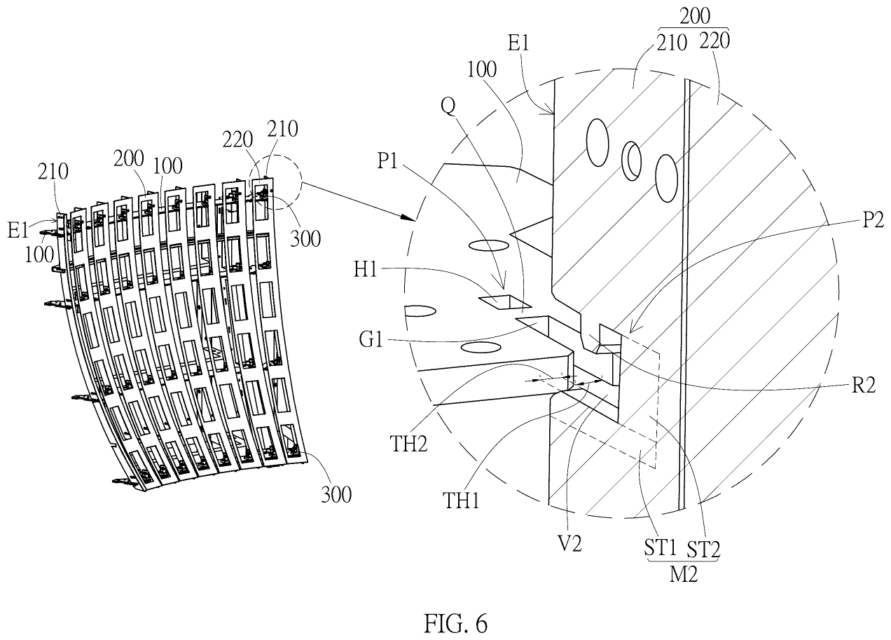

FIG. 6 shows an overview of the assembly of the first brackets 100 and the second brackets 200 on the left, and an enlarged view of a portion of the first bracket (i.e., the first positioning portion P1) and a corresponding portion of the second bracket at a pre-assembly state on the right. Corresponding to the first positioning portions P1 in the first brackets 100, the second brackets 200 may have a plurality of second positioning portions P2. For example, each rib 210 may have a plurality of second positioning portions P2 arranged longitudinally. Specifically, each rib 210 of the second brackets 200 may have a connecting edge E1 facing toward the first brackets 100, and the second positioning portions P2 may be arranged along the connecting edge E1 corresponding to the first positioning portions P1.

Referring to the right part of FIG. 6, each first positioning portion P1 may include a positioning hole H1 and a guiding groove G1 spaced apart from each other, wherein the guiding groove G1 may extend from an edge of the first bracket 100 toward the positioning hole H1 without reaching it. Correspondingly, each second positioning portion P2 may include a guiding piece M2, an opening V2 connected to the guiding piece M2 and facing toward the first bracket 100, and a positioning bump R2 extending longitudinally into the opening V2. Before securing the first bracket 100 and the second bracket 200, the positioning bump R2 may be embedded into the positioning hole H1, and the guiding piece M2 may be inserted into the guiding groove G1 to initially position the first bracket 100 and the second bracket 200. In addition, a separating block Q between the positioning hole H1 and the guiding groove G1 is located in the opening V2 when the first positioning portion P1 is engaged with the second positioning portion P2.

Furthermore, the guiding piece M2 may form a stepped structure and include a first step portion ST1 and a second step portion ST2. The first step portion ST1 may be disposed on the side of the opening V2 opposing the positioning bump R2, and the second step portion ST2 may be disposed on the bottom side of the opening V2 (that is, the side facing the corresponding first positioning portion P1 in the lateral direction). The positioning bump R2 may extend downward from the top edge of the opening V2 toward the first step portion ST1 and be spaced apart from the second step portion ST2. Based on this configuration, the first step portion ST1 of the guiding piece M2 may be inserted into the guiding groove G1 for initial alignment, ensuring the horizontal alignment and angular orientation of the rib 210 of the second bracket 200 relative to the first bracket 100. Then, the rib 210 may be lowered to embed the positioning bump R2 into the positioning hole H1, ensuring the overlapping depth and the vertical level of the rib 210 of the second bracket 200 relative to the first bracket 100. Meanwhile, the second step portion ST2 of the guiding piece M2 may be positioned in the guiding groove G1. The above screwless engagement of the first positioning portion P1 and the second positioning portion P2 can be performed prior to the fastening process using the connecting component 300. Therefore, during the fastening process, the second step portion ST2 can be limited within the guiding groove G1 to confine its linear alignment and angular orientation, thereby reducing misalignment or angular shift of the rib 210 of the second bracket 200 relative to the first bracket 100 while maintaining a working clearance for the connecting (such as screw fastening) process.

In addition, to maintain working clearances for adjusting the first brackets 100 and the second brackets 200 during the connecting or assembling processes, the width TH1 of the guiding groove G1 may be greater than the width TH2 of the guiding piece M2. For example, the width TH1 of the guiding groove G1 may be greater than or equal to 4/3 of the width TH2 of the guiding piece M2.

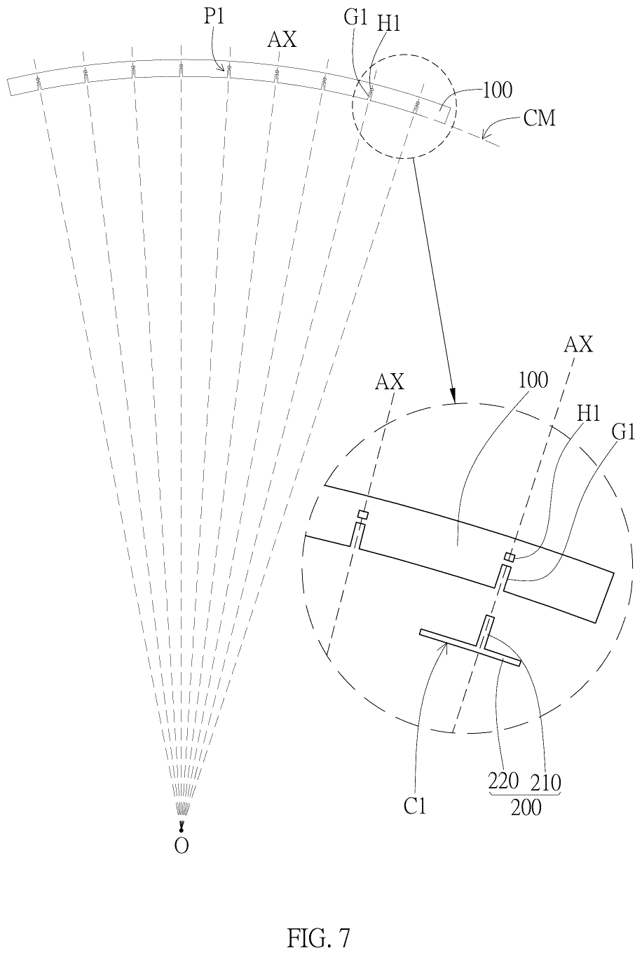

Referring to FIG. 7, the orientation of the first positioning portions P1 in the first bracket 100 is illustrated. For each first positioning portion P1, the axial direction AX of the guiding groove G1 may pass through the positioning hole H1 and the center of curvature O of the virtual curved surface CM, which are respectively located on opposing sides along the axial direction AX. Based on this configuration, when the second brackets 200 are smoothly inserted into the guiding groove G1, the second brackets 200 are limited to the predetermined position and angular orientation such that the bracket plates 220 of the second brackets 200 can be oriented toward the center of curvature O of the virtual curved surface CM. Therefore, the curved positioning surface C1 formed by the bracket plates 220 can correspond to the virtual curved surface CM without misalignment or angular shift. Specifically, based on the positioning hole H1 and the guiding groove G1 arranged along the axial direction AX with a spacing therebetween, the positions of neighboring portions (such as the positioning bump R2 and the guiding piece M2) of the rib 210 can be respectively confined, further enhancing the positioning accuracy of the ribs 210.

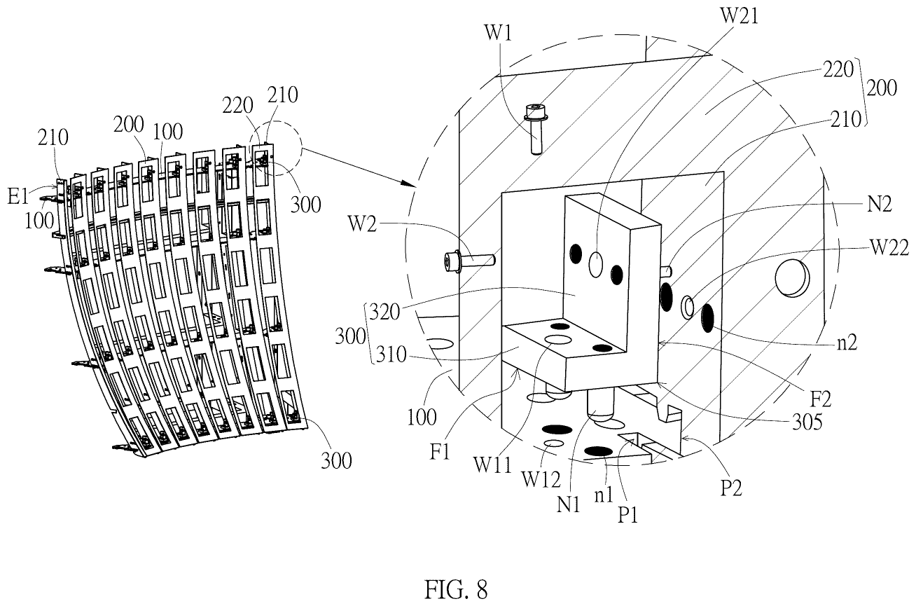

Referring to FIG. 8, after the above positioning and engagement process of the first positioning portions P1 and the second positioning portions P2, further connection means can be applied, including but not limited to screw fastening. For example, the connecting component 300 may be positioned on the crossover region of the first bracket 100 and the second bracket 200, wherein the intersecting edge 305 between the first flange 310 and the second flange 320 is positioned corresponding to the first positioning portion P1. In an embodiment, each first bracket 100 may include at least one first aligning hole n1 and at least one first threaded hole W12. Correspondingly, for each connecting component 300, the first flange 310 may include at least one first aligning component N1 and at least one first through hole W11. Each first aligning component N1 may protrude from a first surface F1 of the first flange 310 toward the first bracket 100, and each first through hole W11 may penetrate the first flange 310. Each first aligning component N1 may be configured to be inserted into the corresponding first aligning hole n1, then a first screw W1 may pass through each first through hole W11 and be screwed into the corresponding first threaded hole W12.

Similarly, the rib 210 of each second bracket 200 may include at least one second aligning hole n2 and at least one second threaded hole W22. Correspondingly, for each connecting component 300, the second flange 320 may include at least one second aligning component N2 having compression elasticity and at least one second through hole W21. Each second aligning component N2 may protrude from a second surface F2 of the second flange 320 toward the rib 210, and each second through hole W21 may penetrate the second flange 320. Each second aligning component N2 may be configured to be inserted into the corresponding second aligning hole n2, then a second screw W2 may pass through each second through hole W21 and be screwed into the corresponding second threaded hole W22.

During the fastening process (such as screwing) between the connecting components 300, the first brackets 100, and the second brackets 200, displacement of the first brackets 100 and the second brackets 200 may occur due to fastening. For example, when the second flange 320 of the connecting component 300 is fastened to the second bracket 200 after fastening the first flange 310 on the first bracket 100, the second bracket 200 may be pushed or pulled by the connection to the connecting component 300, leading to slight displacement. Therefore, since the guiding piece M2 of the rib 210 of the second bracket 200 can be confined within the guiding groove G1 of the first bracket 100 without direct connection or securing, the spacing between the guiding piece M2 and the guiding groove G1 can serve as a working clearance for the fastening process, thereby compensating for assembly tolerances and accumulated errors while preventing large misalignment or angular shift of the ribs 210 of the second brackets 200 relative to the first brackets 100. In addition, the initial positioning process of the first positioning portions P1 and the second positioning portions P2, wherein the positioning components are inserted into the corresponding positioning holes, further reduce or prevent the inconvenience associated with holding (by hand or other tools) the first brackets 100 and the second brackets 200 during the fastening process. Based on this embodiment, the convenience and success rate of assembly operations can be improved, thereby ensuring high stability and positioning accuracy of the final assembled product.

In an embodiment, for the case of fastening operation, the plurality of connecting components 300 may be disposed on the same side of the plurality of the second brackets 200, making the fastening direction for all connecting components 300 consistent, thereby maintaining the possible displacement of the second brackets 200 in a uniform direction.

In summary, by initial positioning of the positioning components and the positioning holes without direct fixation, working clearance can be provided for fastening process while preventing large misalignment or angular shift, thereby improving the positioning accuracy of using the connecting components 300 to secure the first brackets 100 and the second brackets 200.

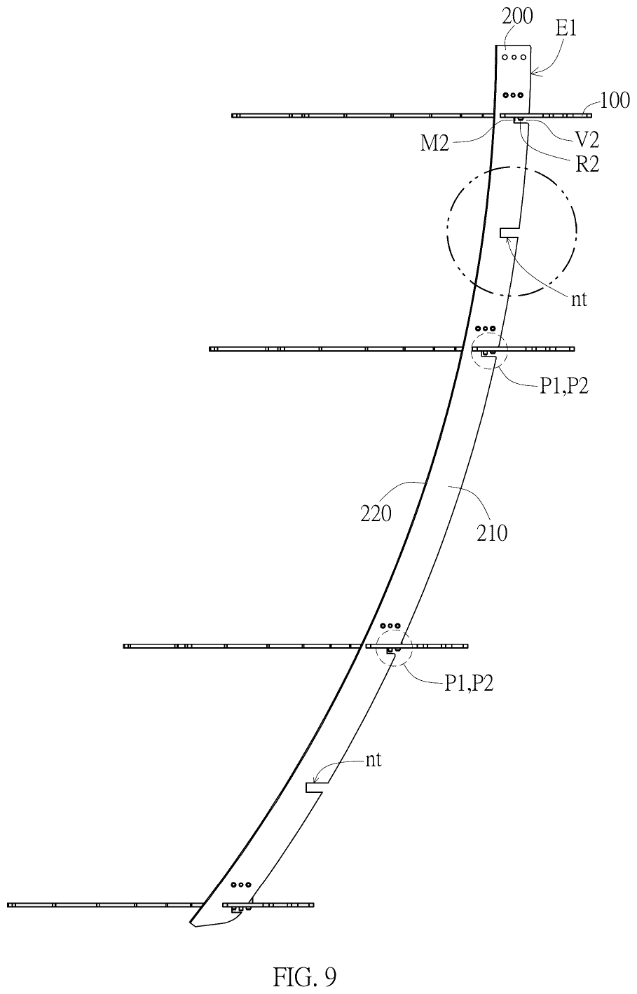

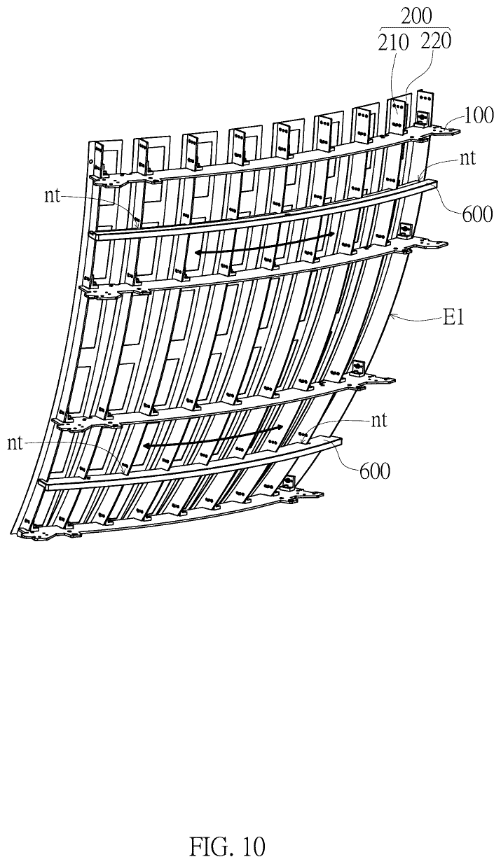

FIG. 9 shows a side view of the first brackets 100 and one of the second brackets 200. After the installation of the second brackets 200 on the first brackets 100, each second bracket 200 is engaged with and supported by the first brackets 100. In addition, the rib 210 of each second brackets 200 may have a connecting edge E1 facing toward the first brackets 100, wherein the second positioning portions P2 are arranged along the connecting edge E1. The connecting edge E1 may have an inspection groove nt spaced apart from the second positioning portions P2 (and thus spaced apart from the first brackets 100). Referring to FIGS. 9 and 10, when the first brackets 100 and the second brackets 200 are assembled in a predetermined configuration (or, in other words, properly assembled), the inspection grooves nt of the ribs 210 arranged side by side are correspondingly aligned, and a connecting curve of the inspection grooves nt has a predetermined curvature. Therefore, when the first brackets 100 and the second brackets 200 are assembled in the predetermined configuration, a lateral inspection tool 600 having the predetermined curvature may be configured to span across and engage with the inspection grooves nt. The lateral inspection tool 600 can laterally slide along the inspection grooves nt. Therefore, the assembly operator may easily determine whether the entire framework is properly assembled by checking the alignment of the inspection grooves nt of the second brackets 200. Specifically, the lateral inspection tool 600 having the predetermined curvature can be inserted into the inspection grooves nt across a plurality of second brackets 200, enabling detection of whether the second brackets 200 have been correctly assembled in the predetermined 3D configuration based on orientation, height, depth, and other factors.

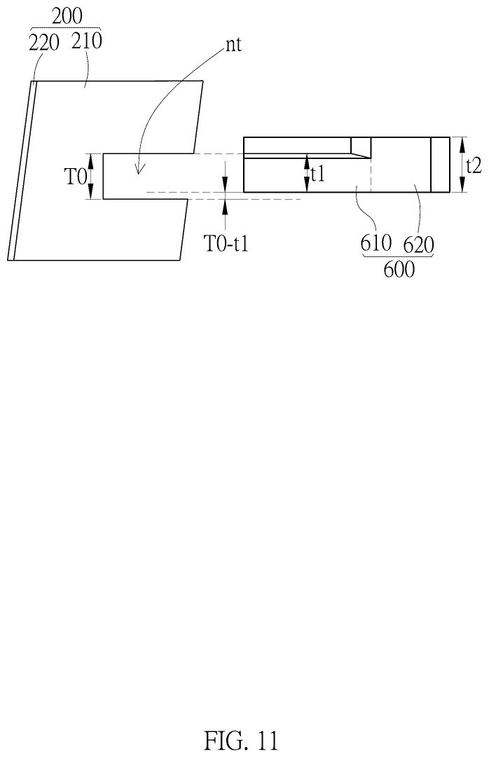

Furthermore, FIG. 11 shows a side view of one of the inspection grooves nt and a portion of the lateral inspection tool 600. The lateral inspection tool 600 may have an inspection bar 610 extending laterally and configured to be inserted into the inspection groove nt, wherein the longitudinal height T0 of each inspection groove nt may be greater than the longitudinal height t1 of the inspection bar 610. In an embodiment, the difference between the height T0 and the height t1 may be less than or equal to 0.3 mm. Therefore, when inserted into the inspection groove nt, the inspection bar 610 can be used to check the alignment of the inspection grooves nt while maintaining a working clearance for the lateral inspection tool 600 to laterally slide along the inspection grooves nt.

In addition, the lateral inspection tool 600 may further have an operation bar 620 extending laterally and connected to the inspection bar 610, wherein the longitudinal height t2 of the operation bar 620 may be greater than the longitudinal height T0 of each inspection groove nt. The inspection bar 610 may be inserted into the inspection grooves nt, and the operation bar 620 may be held to move the inspection bar 610 to slide along the inspection grooves nt. Therefore, the height t2 of the operation bar 620 may be designed based on holding or operation convenience, while the height t1 of the inspection bar 610 may be designed corresponding to the height T0 of the inspection groove nt, allowing the height T0 of the inspection groove nt to be smaller, thereby reducing the impact on structural stability of the second brackets 200. Based on the inspection grooves nt and the corresponding lateral inspection tool 600, the positioning accuracy of the assembly can be easily verified, and the assembly configuration may then be adjusted in response.

In an embodiment, considering the case of inspection and the structural stability, the height T0 of the inspection groove nt may be designed to be less than or equal to 2 mm.

In summary, the positioning accuracy of the structural assembly can be conveniently inspected without using large measuring equipment, thereby facilitating the implementation of curved frame modules with large dimensions.

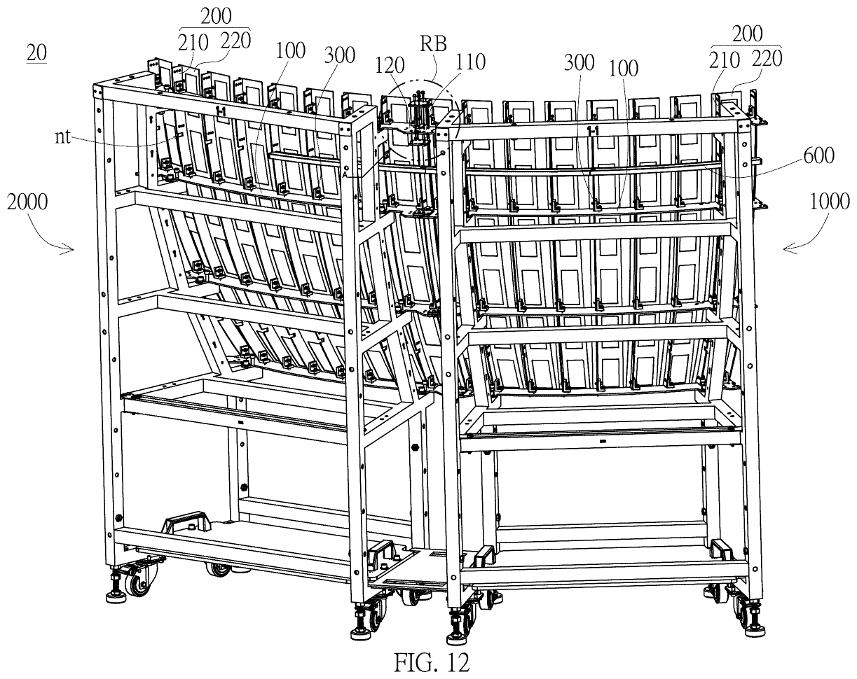

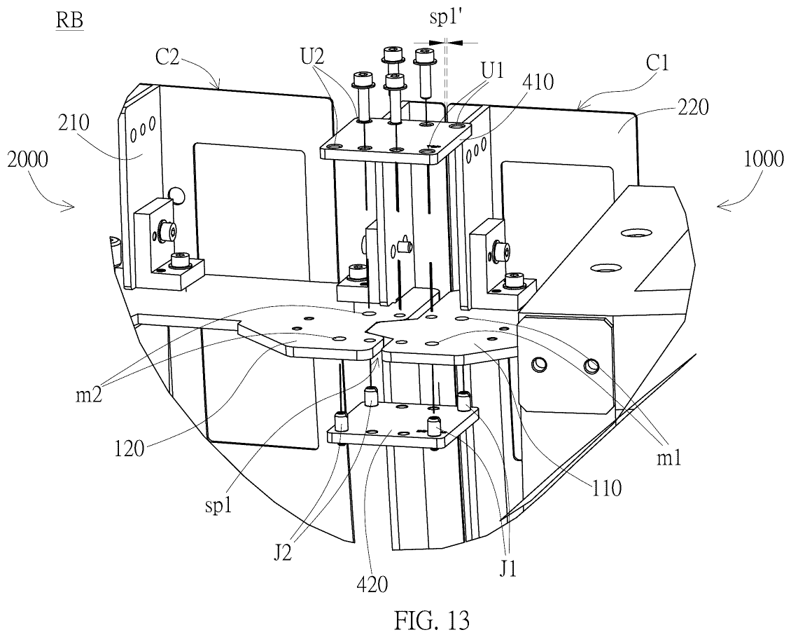

Hereinafter, the connecting configurations of multiple module units will be illustrated referring to FIGS. 12 and 13.

As shown in FIG. 12, in an embodiment, the curved frame module 20 may include a first module unit 1000 and a second module unit 2000 connected laterally, similar to the curved frame module 10 shown in FIG. 1. In this embodiment, various tools or means can be used to check the positioning accuracy of the first module unit 1000 and the second module unit 2000 which are adjacently connected. For example, a leveling instrument can be used to inspect the levelness, and a laser collimator can be used to align the first module unit 1000 and the second module unit 2000, but not limited thereto. In addition, when the first module unit 1000 and the second module unit 2000 are assembled in a predetermined configuration (or, in other words, properly assembled), the abovementioned lateral inspection tool 600 can fit a curvature formed by the connection between the first module unit 1000 and the second module unit 2000. The lateral inspection tool is also able to laterally slide along the inspection grooves nt of the first module unit 1000 and the second module unit 2000 to check whether the curvature in the connecting region between module units is properly formed and the components in each module unit are properly positioned (for example, whether the heights of the corresponding structures are aligned). Based on this configuration, the positioning accuracy of the assembly of the first module unit 1000 and the second module unit 2000 can be easily verified, and the alignment of the module units may then be adjusted in response to the inspection result.

Referring to FIGS. 12 and 13, in an interface region RB where the first module unit 1000 and the second module unit 2000 are connected, at least one first bracket 100 of the first module unit 1000 and at least one first bracket 100 of the second module unit 2000 may respectively have a first engaging structure 110 and a second engaging structure 120, wherein the pair of first brackets 100 having the corresponding first engaging structure 110 and second engaging structure 120 may locate at the same height level and be adjacent to each other. The first engaging structure 110 and the second engaging structure 120 may have matching shapes, enabling a fitting assembly and forming the predetermined curvature of the connection of the first module unit 1000 and the second module unit 2000. In an embodiment, at least a predetermined lateral gap sp1 may be provided between the first engaging structure 110 and the second engaging structure 120, providing a working clearance for assembly and securing operations and compensating for assembly tolerances. Furthermore, the predetermined lateral gap sp1 may also reduce or prevent unexpected collision or compression between the adjacent first engaging structure 110 and second engaging structure 120 as well as between other corresponding structures in the adjacent module units.

In detail, as shown in FIG. 13, the predetermined lateral gap sp1 between the first engaging structure 110 and the second engaging structure 120 can compensate for assembly tolerances and manufacturing tolerances, preventing initial contact (that is, before further securing process) between the first engaging structure 110 and the second engaging structure 120. In addition, the predetermined lateral gap sp1 may contribute to a predetermined gap sp1′ between the corresponding structures, for example, the corresponding bracket plates 220, of the first module unit 1000 and the second module unit 2000. Therefore, the predetermined gap sp1′ may be controlled within a predetermined range to prevent defects potentially caused by insufficient or excessive spacing between the first module unit 1000 and the second module unit 2000. For example, if the first module unit 1000 and the second module unit 2000 are positioned too close, the respectively curved positioning surfaces C1 and C2 may be misaligned or overlapped, leading to discontinuity between the curved positioning surfaces C1 and C2, thereby failing to form an integrated curved or spherical surface as designed, eventually causing suboptimal installation or the infeasibility of installing the predetermined object (such as a display module). In contrast, if the first module unit 1000 and the second module unit 2000 are positioned too far, the ambient light may leak through the gaps between the first module unit 1000 and the second module unit 2000, or the inner structure may be exposed through the gaps, thereby impairing the overall visual appearance. Specifically, when the curved frame module 20 is used to support a display module, the ambient light leakage may interfere with the displayed image, and the exposed inner structure may be noticed by the viewer, thus deteriorating the overall display quality and viewing experience.

In an embodiment, for maintaining proper predetermined lateral gap sp1 and predetermined gap sp1′ in the connection of the first engaging structure 110 and the second engaging structure 120, the curved frame module 20 may further include a first positioning piece 410 and a second positioning piece 420 disposed on opposite sides (for example, on the top and the bottom) of the first engaging structure 110 and the second engaging structure 120, wherein both the first positioning piece 410 and the second positioning piece 420 extend across the first engaging structure 110 and the second engaging structure 120. The first positioning piece 410 and the second positioning piece 420 may be fastened together to hold the first engaging structure 110 and the second engaging structure 120. For example, after adjusting the relative positions of the first module unit 1000 and the second module unit 2000, the first positioning piece 410 and the second positioning piece 420 may be fastened to the first engaging structure 110 and the second engaging structure 120 to fix the module unit 1000 and the second module unit 2000 together.

Furthermore, one of the first positioning piece 410 and the second positioning piece 420 may have at least one boss (such as J1 and J2) facing toward the other. The other one of the first positioning piece 410 and the second positioning piece 420 may correspondingly have at least one engaging hole (such as U1 and U2). At least one of the first engaging structure 110 and the second engaging structure 120 may have at least one engaging through hole (such as m1 and m2). For example, the bosses J1 and J2 protruding from the second positioning piece 420 may respectively pass through the engaging through holes m1 and m2 and then be inserted or embedded into the engaging hole U1 and U2 on the first positioning piece 410 without secure fastening, providing initial alignment of the first engaging structure 110 and the second engaging structure 120. In addition, the first engaging structure 110 and the second engaging structure 120 may each have at least one engaging through hole corresponding to different bosses on the same positioning piece, ensuring the relative positioning between the first engaging structure 110 and the second engaging structure 120. For example, the first engaging structure 110 may have the engaging through holes m1 corresponding to the bosses J1, and the second engaging structure 120 may have the engaging through holes m2 corresponding to the bosses J2.

As mentioned above, the first positioning piece 410 and the second positioning piece 420 can be initially positioned through the engagement of bosses and engaging through holes prior to the fastening process, improving the convenience and accuracy of the fastening process. This concept is similar to the fastening process illustrated above (referring to FIG. 8). Accordingly, detailed description is omitted for brevity.

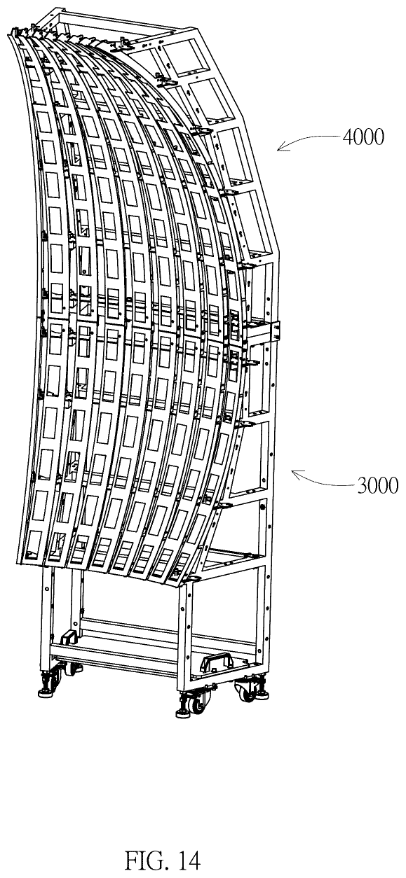

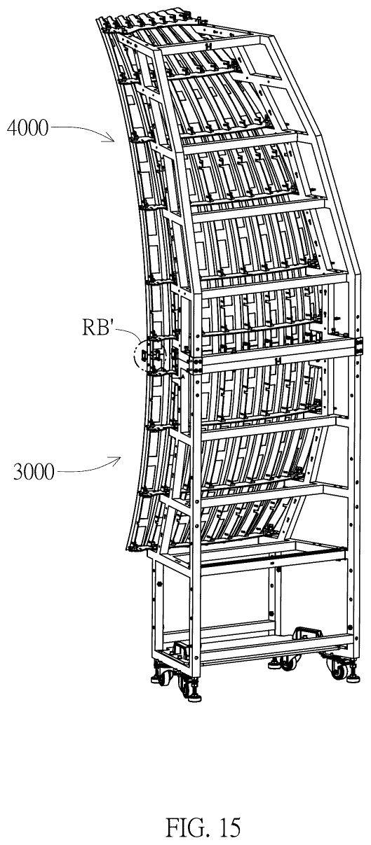

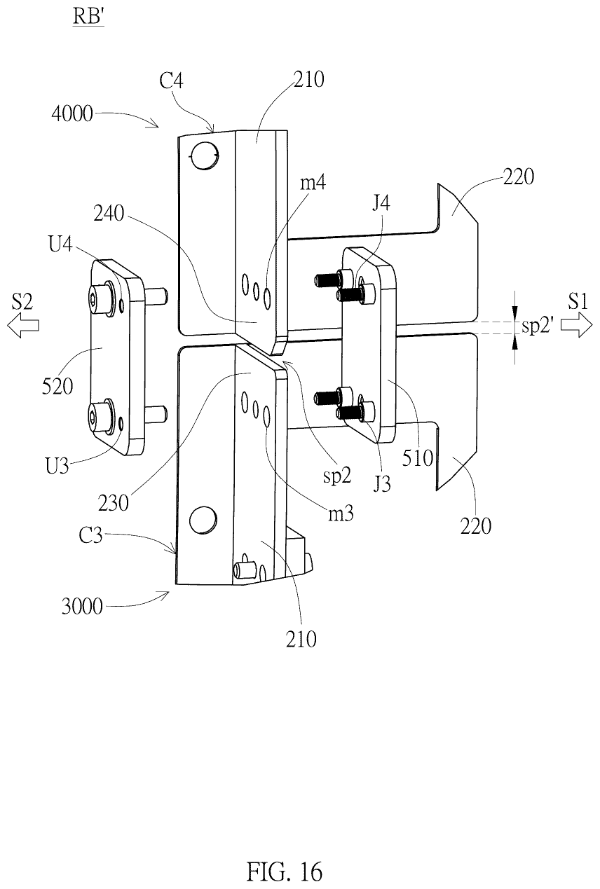

FIGS. 14 and 15 respectively show the front view and the back view of the curved frame module in another embodiment. The curved frame module 30 may include a third module unit 3000 and a fourth module unit 4000 connected longitudinally. Similar to the connection of the first module unit 1000 and the second module unit 2000 in FIGS. 13, FIG. 16 shows the connecting configuration of an interface region RB′ where the third module unit 3000 and the fourth module unit 4000 are connected. At least one rib 210 of the third module unit 3000 and at least one rib 210 of the fourth module unit 4000 may respectively have a third engaging structure 230 and a fourth engaging structure 240, wherein the pair of ribs 210 having the corresponding third engaging structure 230 and fourth engaging structure 240 may be located at the same horizontal position and be adjacent to each other. The third engaging structure 230 and the fourth engaging structure 240 may have matching shapes, enabling a fitting assembly and forming the predetermined curvature of the connection of the third module unit 3000 and the fourth module unit 4000. In an embodiment, at least a predetermined longitudinal gap sp2 may be provided between the third engaging structure 230 and the fourth engaging structure 240, providing a working clearance for assembly and securing operations and compensating for assembly tolerances. Furthermore, the predetermined longitudinal gap sp2 may also reduce or prevent unexpected collision or compression between the adjacent third engaging structure 230 and fourth engaging structure 240 as well as between other corresponding structures in the adjacent module units.

In detail, as shown in FIG. 16, the predetermined longitudinal gap sp2 between the third engaging structure 230 and the fourth engaging structure 240 can compensate for assembly tolerances and manufacturing tolerances, preventing initial contact (that is, before further securing process) between the third engaging structure 230 and the fourth engaging structure 240. In addition, the predetermined longitudinal gap sp2 may contribute to a predetermined gap sp2′ between the corresponding structures, for example, the corresponding bracket plates 220, of the third module unit 3000 and the fourth module unit 4000. Therefore, the predetermined gap sp2′ may be controlled within a predetermined range to prevent defects potentially caused by insufficient or excessive spacing between the third module unit 3000 and the fourth module unit 4000. For example, if the third module unit 3000 and the fourth module unit 4000 are positioned too close, the respective curved positioning surfaces C3 and C4 may be misaligned or overlapped, leading to discontinuity between the curved positioning surfaces C3 and C4, thereby failing to form an integrated curved or spherical surface as designed, eventually causing suboptimal installation or the infeasibility of installing the predetermined object (such as a display module). In contrast, if the third module unit 3000 and the fourth module unit 4000 are positioned too far, the ambient light may leak through the gaps between the third module unit 3000 and the fourth module unit 4000, or the inner structure may be exposed through the gaps, thereby impairing the overall visual appearance. Specifically, when the curved frame module 30 is used to support a display module, the ambient light leakage may interfere with the displayed image, and the exposed inner structure may be noticed by the viewer, thus deteriorating the overall display quality and viewing experience.

Similar to the embodiment shown in FIG. 13, FIG. 16 illustrates the connection configuration in the interface region RB′. To maintain proper predetermined lateral gap sp2 and predetermined gap sp2′ in the connection of the third engaging structure 230 and the fourth engaging structure 240, the curved frame module 30 may further include a third positioning piece 510 and a fourth positioning piece 520 disposed on opposite sides (for example, on the right and the left) of the third engaging structure 230 and the fourth engaging structure 240, wherein both the third positioning piece 510 and the fourth positioning piece 520 extend across the third engaging structure 230 and the fourth engaging structure 240. The third positioning piece 510 and the fourth positioning piece 520 may be fastened together to hold the third engaging structure 230 and the fourth engaging structure 240, wherein the third positioning piece 510 and the fourth positioning piece 520 may each have corresponding position structures. In detail, one of the third positioning piece 510 and the fourth positioning piece 520 may have at least one boss (such as J3 and J4) facing toward the other. The other one of the third positioning piece 510 and the fourth positioning piece 520 may correspondingly have at least one engaging hole (such as U3 and U4). At least one of the third engaging structure 230 and the fourth engaging structure 240 may have at least one engaging through hole (such as m3 and m4). For example, the bosses J3 and J4 protruding from the third positioning piece 510 may respectively pass through the engaging through holes m3 and m4 and then be inserted or embedded into the engaging hole U3 and U4 on the fourth positioning piece 520 without secure fastening, providing initial alignment of the third engaging structure 230 and the fourth engaging structure 240 prior to the fastening process.

In addition, the third engaging structure 230 and the fourth engaging structure 240 may each have at least one engaging through hole corresponding to different bosses on the same positioning piece, ensuring the relative positioning between the third engaging structure 230 and the fourth engaging structure 240. For example, the third engaging structure 230 may have the engaging through holes m3 corresponding to the bosses J3, and the fourth engaging structure 240 may have the engaging through holes m4 corresponding to the bosses J4.

As mentioned above, the third positioning piece 510 and the fourth positioning piece 520 can be initially positioned through the engagement of bosses and engaging through holes prior to the fastening process, improving the convenience and accuracy of the fastening process. This concept is similar to the fastening process illustrated above (referring to FIG. 8). Accordingly, detailed description is omitted for brevity.

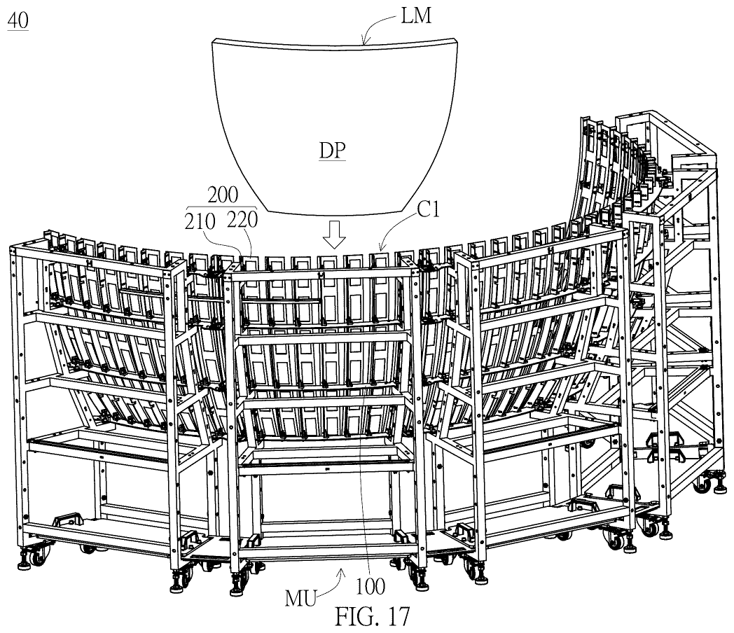

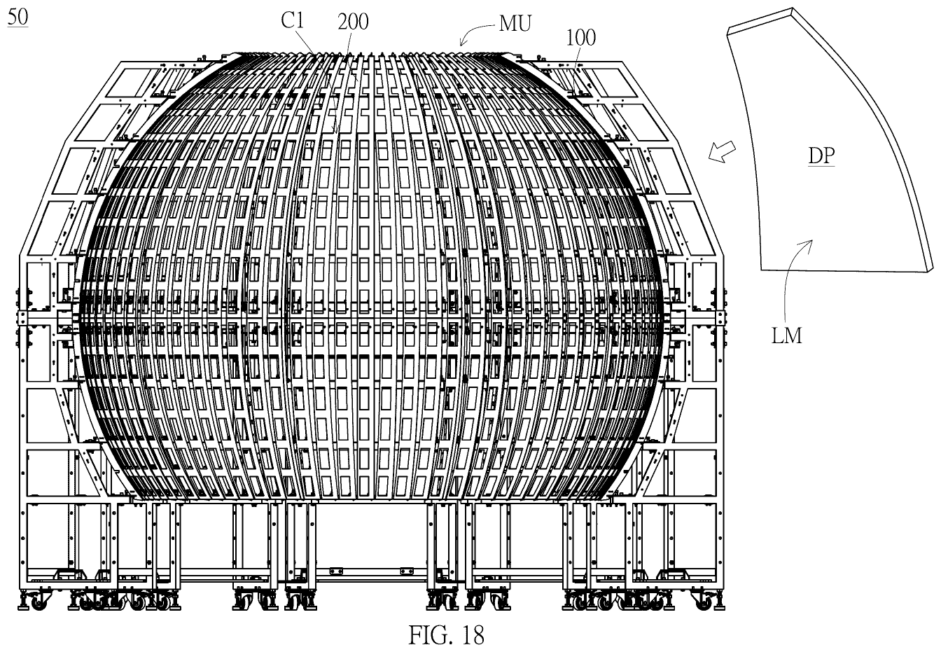

Hereinafter, the applications of the curved frame module provided in various embodiments in the present disclosure will be illustrated referring to FIGS. 17 and 18.

As mentioned above, the curved frame module may include on or more module units to construct the curved positioning surface for various applications, such as installation of the predetermined object. For example, referring to FIGS. 17 and 18, curved frame modules 40 and 50 may be assembled with multiple module units MU in lateral and/or longitudinal connections similar to the abovementioned positioning configurations, wherein for each module unit MU, the second brackets 200 may together form the corresponding curved positioning surface C1. At least one display panel DP may be disposed on the curved positioning surface(s) C1 of the curved display module 40 (or 50) to form a curved display module. Each module unit MU may correspond to a display panel DP, but not limited thereto. For example, a display panel DP with curved shape may be attached to the curved positioning surface C1 of the corresponding module unit MU (for example, to be attached to the second brackets 200 which include metallic magnetic materials) using magnetic components. Based on the precise positioning and assembly of the curved frame modules 40 and 50, the resulting curved positioning surface C1 can be formed with minor assembly errors or dimensional tolerances, eliminating misalignment, deformation, or distortion, thereby matching the shape of the display panel DP. Specifically, when multiple display panels DP are integrated to form a large display, the alignment errors can be prevented or eliminated using the curved display module provided in the present disclosure, thereby enhancing the integration integrity and final visual performance of the curved or spherical display.

In addition, since segmented components (such as the first brackets 100 and the second brackets 200) are used to assemble the curved frame modules 40 and 50 as well as the corresponding curved display modules, the volume and weight of each component can be reduced, facilitating fabrication, transportation, and handling during assembly of each component. Moreover, various positioning designs and structures are applied to assist in the assembly process while maintaining working clearances, improving convenience of the assembly and the positioning accuracy of the final product. Therefore, based on this embodiment, multiple module units MU can be easily utilized to assemble the curved frame module 40 and 50 with large dimensions as well as the corresponding curved display modules, which can be further applied to scenarios requiring large volume capacity such as installation platforms, presentation platforms, or dome display systems.

Furthermore, each display panel DP may have a display surface LM facing away from the corresponding curved positioning surface C1. The plurality of the display surface LM in the curved frame module 40 or 50 may together form an integrated display surface surrounding (or partially surrounding) the viewer, providing enhanced sense of enclosure or immersion.

In the various embodiment described above, the present disclosure provides a curved frame module and a curved display module assembled by segmented components of reduced volume and weight, facilitating fabrication, transportation, and handling of the components. Moreover, various positioning designs and structures are applied to ensure the assembly accuracy of a large number of components, reducing or preventing assembly defects caused by the difficulty in controlling the curvature and angular precision of three-dimensional curved or spherical structures, or by unexpected thermal deformation. The positioning structures or designs are provided with predetermined position limitations and working clearances, thereby facilitating the proper positioning while preserving flexibility for adjustment and tolerance compensation. Therefore, the curved frame module and the curved display module provided by the present disclosure utilize segmented components with high assembly reproducibility to form curved or spherical surfaces with consistency in curvature, thereby enabling applications such as installation platforms, presentation platforms, or dome display systems. Moreover, the curved frame module and the curved display module provided by the present disclosure are easy to assemble and adjust to form desired configurations, providing enhanced visual effects and immersion, thereby improving the viewing or observation experience.

The above context merely illustrates some preferred embodiments of the present disclosure. It should be noted that various changes and modifications can be made to the present disclosure without departing from the spirit and principles of the present disclosure. It should be understood by a person having ordinary skill in the art that the present disclosure is defined by the scope of the appended patent claims, and that various possible substitutions, combinations, modifications, and adaptations, which align with the intent of the present disclosure, fall within the scope of the present disclosure as defined by the appended patent claims.

What is claimed is:

1. A curved frame module comprising at least one module unit(s), each of the at least one module unit(s) comprising:
a base frame comprising:
a first frame;
a second frame, wherein a virtual curved surface is defined to span from the first frame to the second frame; and
a plurality of ledges respectively protruding from the first frame and the second frame;
a plurality of first brackets disposed on the plurality of ledges and laterally extending along the virtual curved surface, wherein each of the plurality of first brackets has a plurality of first positioning portions, each of the plurality of first positioning portions comprises:
a positioning hole; and
a guiding groove spaced apart from the positioning hole, wherein an axial direction of the guiding groove passes through the positioning hole and a center of curvature of the virtual curved surface;
a plurality of second brackets longitudinally extending along the virtual curved surface, wherein each of the plurality of second brackets at least has a rib, each of the ribs has a plurality of second positioning portions, each of the plurality of second positioning portions is disposed corresponding to one of the plurality of first positioning portions and comprises:
a guiding piece configured to be inserted into the guiding groove;
an opening connected to the guiding piece and facing toward the corresponding one of the plurality of first brackets; and
a positioning bump longitudinally extending into the opening and configured to be inserted into the positioning hole; and
a plurality of connecting components, each of the plurality of connecting components having:
a first flange connected to a corresponding one of the plurality of brackets; and
a second flange connected to a corresponding one of the ribs.

2. The curved frame module of claim 1, wherein for each of the at least one module unit(s), each of the plurality of second brackets further has a bracket plate cross-connected to the rib and positioned corresponding to the virtual curved surface, the bracket plates of the plurality of second brackets together form a curved positioning surface, and the curved positioning surface is configured for placing at least one display panel.

3. The curved frame module of claim 1, wherein an intersecting edge between each of the first flanges and a corresponding one of the second flanges is positioned corresponding to one of the plurality of first positioning portions.

4. The curved frame module of claim 1, wherein:
each of the plurality of first brackets comprises:
at least one first aligning hole(s); and
at least one first threaded hole(s); and
each of the first flanges comprises:
at least one first aligning component(s) protruding from a first surface of the first flange facing toward a corresponding one of the plurality of first brackets, and the at least one first aligning component(s) is configured to be inserted into the at least one first aligning hole(s); and
at least one first through hole(s) penetrating the first flange and corresponding to the at least one first threaded hole(s),
wherein at least one first screw(s) is configured to pass through the at least one first through hole(s) and be screwed into the at least one first threaded hole(s).

5. The curved frame module of claim 1, wherein:
each of the ribs comprises:
at least one second aligning hole(s); and
at least one second threaded hole(s); and
each of the second flanges comprises:
at least one second aligning component(s) protruding from a second surface of the second flange facing toward a corresponding one of the ribs, and the at least one second aligning component(s) is configured to be inserted into the at least one second aligning hole(s); and
at least one second through hole(s) penetrating the second flange and corresponding to the at least one second threaded hole(s),
wherein at least one second screw(s) is configured to pass through the at least one second through hole(s) and be screwed into the at least one second threaded hole(s).

6. The curved frame module of claim 1, wherein each of the plurality of ledges has a reference hole, the reference hole and the center of curvature of the virtual curved surface is separated by a predetermined radial distance, and the plurality of first brackets are positioned on the plurality of ledges based on the reference holes.

7. The curved frame module of claim 1, wherein a width of the guiding groove is greater than or equal to 4/3 of a width of the guiding piece.

8. The curved frame module of claim 1, wherein each of the plurality of first positioning portions further comprises a separating block disposed between the positioning hole and the guiding groove, and the separating block is configured to be placed in the opening.

9. The curved frame module of claim 1, wherein:
the at least one module unit(s) comprise a first module unit and a second module unit laterally adjacent to each other,
at least one of the plurality of first brackets in the first module unit has a first engaging structure,
at least one of the plurality of first brackets in the second module unit has a second engaging structure corresponding to the first engaging structure, the first engaging structure and the second engaging structure have mating shapes, and at least a predetermined lateral gap is provided between the first engaging structure and the second engaging structure; and
the curved frame module further comprises a first positioning piece and a second positioning piece disposed on opposite sides of the first engaging structure and the second engaging structure,
both the first positioning piece and the second positioning piece extend across the first engaging structure and the second engaging structure, and the first positioning piece and the second positioning piece are fastened together to hold the first engaging structure and the second engaging structure therebetween.

10. The curved frame module of claim 9, wherein one of the first positioning piece and the second positioning piece has at least one boss(es) facing toward the other one of the first positioning piece and the second positioning piece, the other of the first positioning piece and the second positioning piece has at least one engaging hole(s) corresponding to the at least one boss(es), at least one of the first engaging structure and the second engaging structure has at least one engaging through hole(s) corresponding to the at least one boss(es) and the at least one engaging hole(s), and the at least one boss(es) correspondingly pass through the at least one engaging through hole(s) and are inserted into the at least one engaging hole(s).

11. The curved frame module of claim 10, wherein the at least one engaging through hole(s) include a first engaging through hole and a second engaging through hole respectively located on the first engaging structure and the second engaging structure, and the first engaging through hole and the second engaging through hole respectively correspond to different ones of the at least one boss(es).

12. The curved frame module of claim 1, wherein:
for each of the ribs, the rib has a connecting edge facing toward the plurality of first brackets, the plurality of second positioning portions are arranged along the connecting edge, and the connecting edge has an inspection groove spaced apart from the plurality of second positioning portions and the plurality of first brackets; and
when the plurality of first brackets and the plurality of second brackets are assembled in a predetermined configuration, the inspection grooves of the ribs arranged side by side are correspondingly aligned, and a connecting curve of the inspection grooves has a predetermined curvature.

13. The curved frame module of claim 12, when the plurality of first brackets and the plurality of second brackets are assembled in the predetermined configuration, a lateral inspection tool having the predetermined curvature is configured to span across and engage with the inspection grooves, and the lateral inspection tool is able to laterally slide along the inspection grooves.

14. The curved frame module of claim 13, wherein the lateral inspection tool have an inspection bar extending laterally and configured to be inserted into the inspection grooves, and a longitudinal height of each of the inspection grooves is greater than a longitudinal height of the inspection bar with a difference less than or equal to 0.3 mm.

15. The curved frame module of claim 14, wherein the lateral inspection tool further has an operation bar extending laterally and connected to the inspection bar, and a longitudinal height of the operation bar is greater than the longitudinal height of each of the inspection grooves.

16. The curved frame module of claim 13, wherein the at least one module unit(s) comprise a first module unit and a second module unit laterally adjacent to each other, the lateral inspection tool fits a curvature formed by connection between the first module unit and the second module unit, and the lateral inspection tool is able to laterally slide along the inspection grooves in the first module unit and the second module unit.

17. The curved frame module of claim 1, wherein the base frame have at least one base support(s) configured to support the base frame on a reference surface, and a height of the at least one base support(s) relative to the reference surface is adjustable.

18. The curved frame module of claim 1, wherein:
the at least one module unit(s) comprise a third module unit and a fourth module unit longitudinally adjacent to each other,
at least one of the ribs in the third module unit has a third engaging structure, at least one of the ribs in the fourth module unit has a fourth engaging structure corresponding to the third engaging structure, the third engaging structure and the fourth engaging structure have mating shapes, and
at least a predetermined longitudinal gap is provided between the third engaging structure and the fourth engaging structure; and
the curved frame module further comprises a third positioning piece and a fourth positioning piece disposed on opposite sides of the third engaging structure and the fourth engaging structure,
both the third positioning piece and the fourth positioning piece extend across the third engaging structure and the fourth engaging structure, and the third positioning piece and the fourth positioning piece are fastened together to hold the third engaging structure and the fourth engaging structure therebetween.

19. The curved frame module of claim 18, wherein one of the third positioning piece and the fourth positioning piece has at least one boss(es) facing toward the other of the third positioning piece and the fourth positioning piece, the other of the third positioning piece and the fourth positioning piece has at least one engaging hole(s) corresponding to the at least one boss(es), at least one of the third engaging structure and the fourth engaging structure has at least one engaging through hole(s) corresponding to the at least one boss(es) and the at least one engaging hole(s), and the at least one boss(es) correspondingly pass through the at least one engaging through hole(s) and are inserted into the at least one engaging hole(s).

20. The curved frame module of claim 19, wherein each of the third engaging structure and the fourth engaging structure has the at least one engaging through hole(s) corresponding to different ones of the at least one boss(es).

21. The curved frame module of claim 1, wherein:
each of the guiding pieces forms a stepped structure and comprises:
a first step portion disposed on a side of the opening opposing the positioning bump; and
a second step portion disposed on a bottom side of the opening; and
the positioning bump extends toward the first step portion and is spaced apart from the second step portion.

22. A curved display module comprising:
the curved frame module of claim 1, wherein for each of the at least one module unit(s), the plurality of second brackets together form a curved positioning surface; and
at least one display panel disposed on the curved positioning surface and having a display surface facing away from the curved positioning surface.
